(19) United States
(12) Patent Application Publication
(10) Pub. No.: US 2016/0295796 A1
(43) Pub. Date: Oct. 13, 2016

(54) Method for operating an agricultural harvesting vehicle, and control device for implementing the method

(71) Applicant: CLAAS SAULGAU GMBH, BAD SAULGAU (DE)

(72) Inventor: Josef Fischer, WARTHAUSEN (DE)

(21) Appl. No.: 15/089,785

(22) Filed: Apr. 4, 2016

(30) Foreign Application Priority Data
Apr. 7, 2015 (DE) 102015105217.2

(51) Int. Cl. A01D 34/00

(52) U.S. Cl. CPC A01D 34/006; A01D 2101/00

(57) ABSTRACT

A method for operating an agricultural harvesting vehicle embodying a carrier vehicle and a front attachment includes measuring travel over a local ground-level change, such as a local bump, a local depression or both using at least one acceleration sensor and, depending upon the measured travel, counteracting pitch motions or rolling motions of the front attachment caused by travel over the local ground-level change.

### CROSS-REFERENCE TO A RELATED APPLICATION

The invention described and claimed hereinbelow is also described in German Patent Application DE 10 2015 105 217.2, filed on Apr. 7, 2015. The German Patent Application, the subject matters of which is incorporated herein by reference, provides the basis for a claim of priority of invention under 35 U.S.C. 119(a)-(d).

### BACKGROUND OF THE INVENTION

The present invention relates to a method for operating an agricultural harvesting vehicle that includes a carrier vehicle and a front attachment, and to a control device for carrying out the method.

FIG. 1 presents a front view and FIG. 4 presents a side view of an agricultural harvesting vehicle 1 designed as a forage harvester. The harvesting vehicle 1 comprises a carrier vehicle 2 and a front attachment 3, which is coupled to the carrier vehicle 2 in the front region thereof, wherein, in the case of a forage harvester, the front attachment 3 is a so-called maize front attachment.

FIGS. 1 and 4 show the agricultural vehicle 1, which is designed as a forage harvester, during harvesting use on a field 4 having a homogeneous ground contour. For harvesting use, the so-called working height X of the front attachment 3 relative to the field 4 is adjusted with the aid of a lifting-unit cylinder 5. In order to maintain an identical working height X7 and X8, of the front attachment 3 relative to the field 4 at both ends or sides 7 and 8, respectively, during harvesting, as viewed transversely to the direction of travel 6 of the harvesting vehicle 1, the front attachment 3 comprises a so-called sensor device 9 and 10 in the region of its two sides 7 and 8, respectively. The sensor devices 9, 10 measure the working height X7 and X8 at the sides 7 and 8, respectively, of the front attachment 3. Consequently, if there is a deviation between these working heights X7, X8, a cross-leveling cylinder 11 can be activated in order to eliminate this deviation between these working heights X7, X8.

From practical application, it is therefore known that a defined working height X of the front attachment 3 relative to the field 4 is adjusted with the aid of the lifting-unit cylinder 5 for the harvesting operation or harvesting use of an agricultural harvesting vehicle 1, which comprises a carrier vehicle 2 and a front attachment 3.

Furthermore, it is known that the sensor devices 9, 10 assigned to the sides 7, 8 of the front attachment 3 detect the working heights X7 and X8, respectively, at the sides 7, 8 of the front attachment 3, so that if a different working height with respect to the field 4 sets in across the width of the front attachment 3, as viewed transversely to the direction of travel 6 of the harvesting vehicle 1, this set in different working height can be compensated for by activating the cross-leveling cylinder 11.

Gradual changes in the ground contour of the field 4 can be compensated for by using the procedure known from practical applications. However, if the harvesting vehicle 1 travels over local, suddenly occurring or singular ground-level changes of the ground contour of the field 4, in particular, bumps or depressions, resultant changes in the working height X across the width of the front attachment 3 cannot be compensated for quickly enough and, therefore, can be compensated for only with delay, whereby bouncing of the front attachment 3 can be induced. This can be the case, for example, when the harvesting vehicle 1 enters a depression and does not react with a lifting motion for the front attachment 3 until the harvesting vehicle 1 emerges from the depression.

FIGS. 2 and 5 show a situation, for example, which sets in during practical application when a wheel of the carrier vehicle 2 travels over a local depression 12. FIGS. 3 and 6 each show views of a harvesting vehicle 1 when traveling over a local bump 13 on the field 4. Pitch motions or rolling motions of the carrier vehicle 2 caused by traveling over a local, suddenly occurring depression 12 or bump 13 are transferred in entirety to the front attachment 3, since the pitch or rolling motions cannot be compensated for quickly enough by the use of the sensor devices 9, 10 and by a conventional use of the cross-leveling cylinder 11. As shown in FIGS. 2, 5, by way of example, if the harvesting vehicle 1 travels with one wheel over the local depression 12 shown, the side 7 of the front attachment 3 facing this depression 12 lowers toward the ground, whereas the opposite side 8 of the front attachment 3 is lifted off the field 4, and so a greatly differing working height X sets in across the width of the front attachment 3.

The same applies similarly, according to FIGS. 3 and 6, when traveling over a local bump 13. That is, when the local bump 13 is traveled over, the side 8 of the front attachment 3 facing the bump 13 moves further away from the ground contour, whereas the opposite side 7 of the front attachment 3 lowers further in the direction toward the ground contour of the field 4. An incorrect position of the front attachment 3 sets in in this case as well.

### SUMMARY OF THE INVENTION

The present invention overcomes the shortcomings of known arts, such as those mentioned above.

To that end, the present invention provides a novel method for operating an agricultural harvesting vehicle and a control device for carrying out the method.

The method for operating an agricultural harvesting vehicle that includes a carrier vehicle and a front attachment, and the control device for carrying out the method, avoids that rolling motions and/or pitch motions of the carrier vehicle in the region of the front attachment caused by traveling over a local ground-level change (e.g., a local bump and/or a local depression) result in different working heights across the width of the front attachment.

According to the invention, travel over a local ground-level change, in particular a local bump and/or a local depression, is measured with the aid of at least one acceleration sensor, wherein, depending thereon, pitch motions and/or rolling motions of the front attachment induced by travel over the local ground-level change, are counteracted.

With the present invention, it is proposed for the first time that it is detected, with the aid of at least one acceleration sensor, whether an agricultural harvesting vehicle is traveling over a local ground-level change, in particular a local bump and/or a local depression. If the travel over a local ground-level change, in particular a local bump and/or a local depression, is detected, control measures are implemented to prevent resultant pitch motions and/or rolling motions from being transferred to the front attachment or affecting the working height of the front attachment. As a result, the potential harvesting result can be improved. In addition, damage to the front attachment is prevented, i.e., the front attachment is prevented from striking the ground.

Preferably, the travel over a local ground-level change, in particular, a local bump and/or a local depression, is detected via the measurement signal of the acceleration sensor (or each acceleration sensor) in that the measured signal has a curve that is characteristic in terms of intensity and duration.

If the measured signal of the acceleration sensor (or each acceleration sensor) does have a curve that is characteristic in terms of intensity and duration, the travel over a local ground-level change, in particular, a local bump and/or a local depression, can be easily and reliably deduced by the control. As a result, it is then possible to easily and reliably implement measures to prevent resultant rolling motions and/or pitch motions of the carrier vehicle from being transferred to the front attachment, so that the working height of the front attachment, as viewed across the width thereof, is not adversely affected.

According to an embodiment, pitch motions of the front attachment caused by travel over a local ground-level change, in particular, a local bump and/or a local depression, are actively compensated for by activation of a lifting-unit cylinder. Rolling motions of the front attachment caused by travel over a local ground-level change, in particular a local bump and/or a local depression, are passively counteracted by activation of a cross-leveling cylinder.

Pitch motions are preferably actively compensated for by an activation of the lifting-unit cylinder. Rolling motions of the front attachment, however, are passively compensated for by activation of the cross-leveling cylinder in that the cross-leveling cylinder is preferably transferred into a so-called floating position in order to decouple the front attachment from the carrier vehicle with respect to the cross-leveling cylinder. The inertia of the front attachment then prevents rolling motions of the carrier vehicle from being transferred to the front attachment.

### BRIEF DESCRIPTION OF THE DRAWINGS

Further features and advantages of the invention will become apparent from the description of embodiments that follows, with reference to the attached figures, wherein:

FIG. 1 presents a front view of an agricultural harvesting vehicle;

FIG. 2 presents the front view from FIG. 1 during travel over a local depression; presents the front view from FIG. 1 during travel over a local bump;

FIG. 4 presents a side view of the agricultural harvesting vehicle depicted in FIG. 1;

FIG. 5 presents the side view from FIG. 4 during travel over a local depression;

FIG. 6 presents the side view from FIG. 4 during travel over a local bump;

FIG. 7 presents the front view of an agricultural harvesting vehicle during travel over a local bump, where the harvesting vehicle is operated to implement the invention;

FIG. 8 presents a front view of the agricultural harvesting vehicle depicted in FIG. 7, during travel over a local depression, where the harvesting vehicle is operated to implement the invention;

FIG. 9 presents a side view of the agricultural harvesting vehicle depicted in FIG. 7, during travel over a local bump, where the harvesting vehicle is operated to implement the invention; and

FIG. 10 presents a side view of the agricultural harvesting vehicle depicted in FIG. 7, during travel over a local depression, where the harvesting vehicle is operated to implement the invention.

### DETAILED DESCRIPTION OF THE PREFERRED EMBODIMENTS

The following is a detailed description of example embodiments of the invention depicted in the accompanying drawings. The example embodiments are presented in such detail as to clearly communicate the invention and are designed to make such embodiments obvious to a person of ordinary skill in the art. However, the amount of detail offered is not intended to limit the anticipated variations of embodiments; on the contrary, the intention is to cover all modifications, equivalents, and alternatives falling within the spirit and scope of the present invention, as defined by the appended claims.

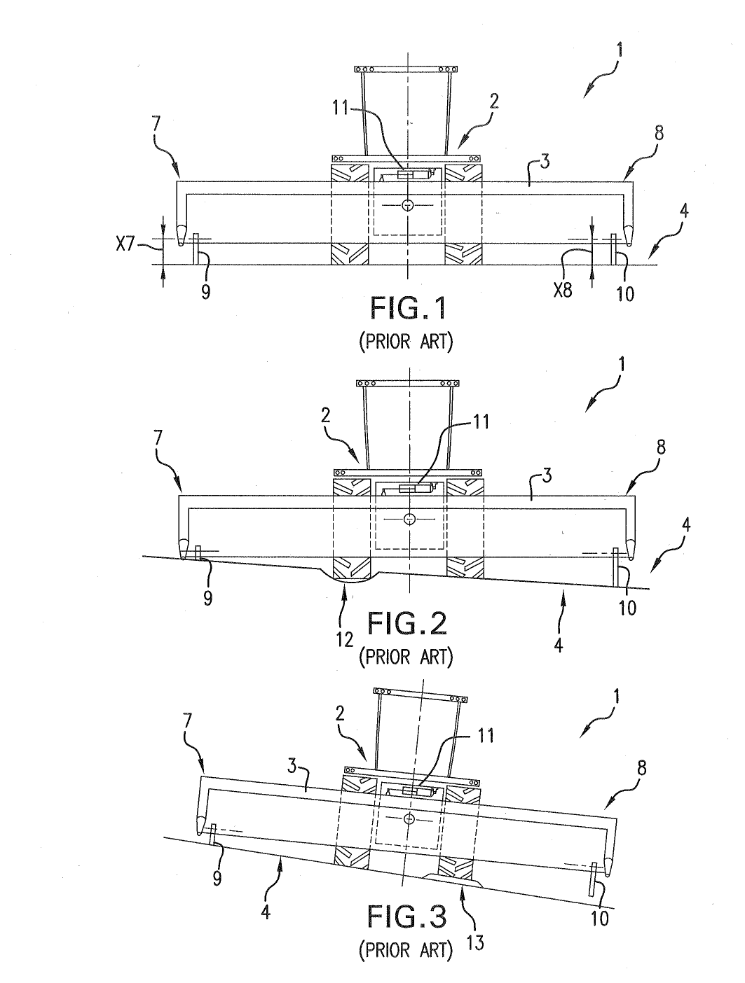

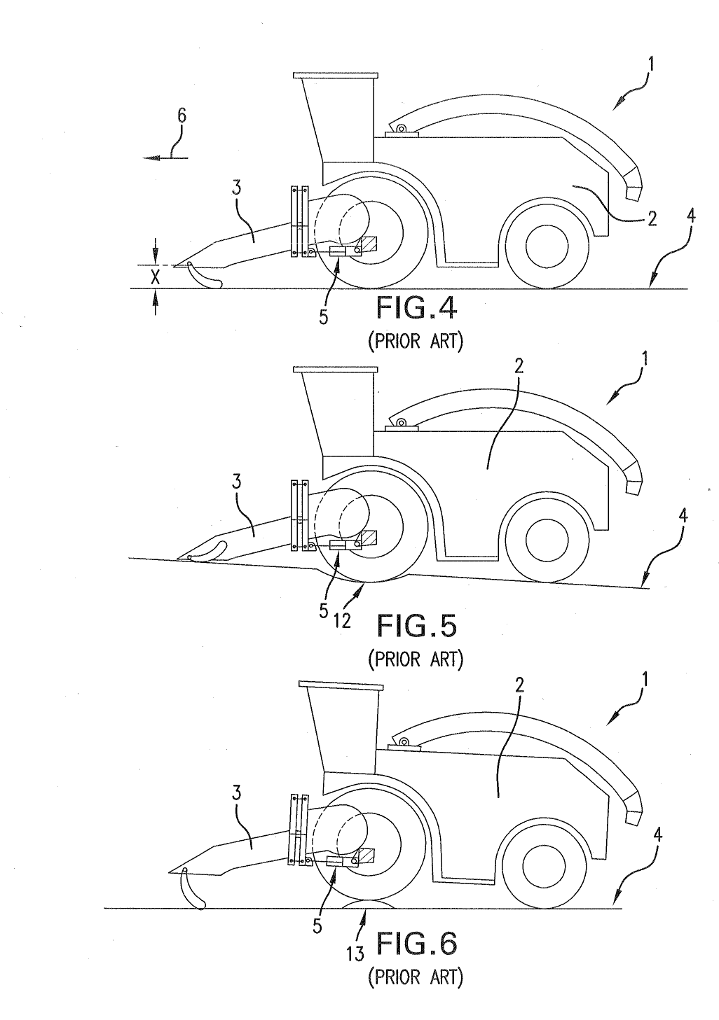

As described above, the present invention relates to a method for operating an agricultural harvesting vehicle and to a control device for carrying out the method. And as described above in connection with FIGS. 1 to 6, an agricultural harvesting vehicle 1 comprises a carrier vehicle 2 and a front attachment 3. When the agricultural harvesting vehicle 1 is a forage harvester, the front attachment 3 is preferably designed as a maize front attachment.

During harvesting use, the agricultural harvesting vehicle 1 is moved along a field 4. Such a field 4 typically has a homogeneous ground contour, which changes relatively slowly. And as described above in connection with FIGS. 1 to 6, effects of a slowly changing ground contour on a working height X of the front attachment 3, which is fixedly set via the lifting cylinder 5, can be compensated for by the cross-leveling cylinder 11, and so the same identical working heights X7, X8, can be set on opposite sides 7, 8, as viewed across the width of the front attachment 3. The sensor devices 9, 10, acting at the sides 7, 8 of the front attachment 3 are used for this purpose.

The present invention prevents pitch motions and/or rolling motions of the carrier vehicle 2, caused by traveling over a local ground-level change, in particular, by traveling over a local depression 12 or by traveling over a local bump 13, from negatively affecting the front attachment 3, specifically, in such a way that different working heights relative to the field 4 set in during travel over a local ground-level change (e.g., a local depression or a local bump), and the front attachment 3 therefore assumes an incorrect position.

A local ground-level change, in particular, a local depression or bump, is intended to mean a sudden, spontaneously occurring, spatially narrowly limited ground-level change of the ground contour of the field. A local ground-level change also can be a stepped drop or rise of the ground contour of the field.

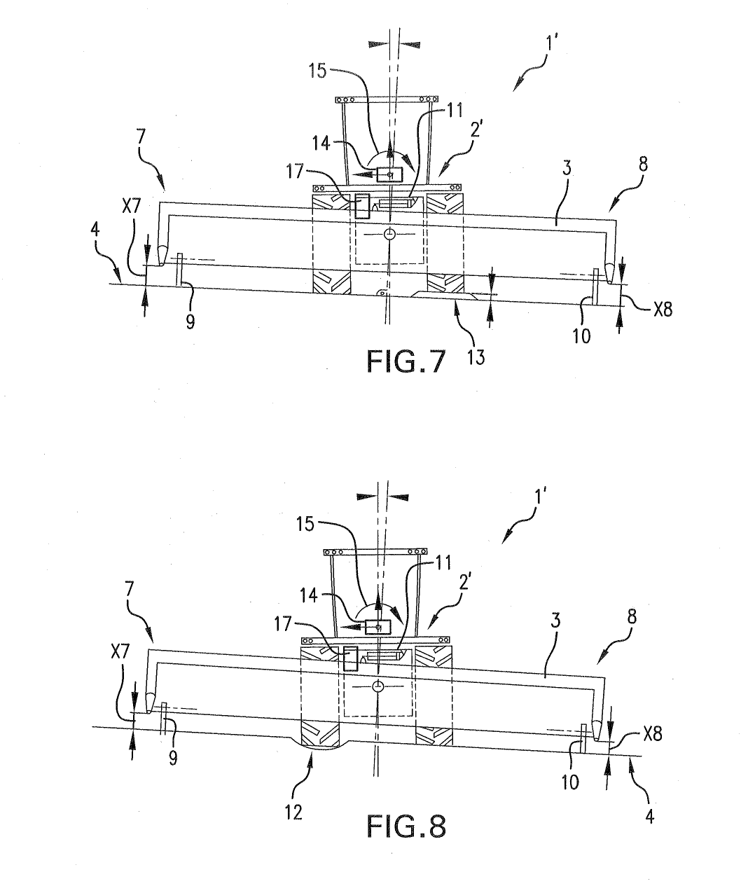

With the present invention, it is proposed that the travel over a local ground-level change, in particular, a local bump 13 and/or a local depression 12, is measured with the aid of at least one acceleration sensor 14, as found in the inventive agricultural working vehicle 1′ depicted in FIGS. 7-10. Depending on the measured signal provided by the acceleration sensor 14, or each acceleration sensor 14, pitch motions and/or rolling motions of the front attachment 3 caused by travel over the local ground-level change such as the local bump 13 and/or the local depression 12, are counteracted. Thus, if the front attachment 2 of the agricultural harvesting vehicle 1′ travels over a local ground-level change such as a local bump 13 and/or a local depression 12, it is ensured by implementation of the inventive method that the working height X of the front attachment 3 basically does not change, as viewed across the width thereof, that is, an approximately identical working height X relative to the field 4 can be maintained on both sides 7, 8 of said front attachment and between said sides.

In the exemplary embodiments shown in FIGS. 7 to 10, the travel over a local depression 12 or a local bump 13 is detected with the aid of an acceleration sensor 14 assigned to the carrier vehicle 2′, which sensor detects accelerations in multiple directions simultaneously. In contrast thereto, it also is possible to provide multiple acceleration sensors 14, each of which can detect an acceleration in only one direction, depending on the installation position thereof. The use of such one-dimensional acceleration sensors 14 is more cost-effective. Multiple acceleration sensors must be used in this case, however.

In addition, in contrast to the exemplary embodiments from FIGS. 7 to 10, it is possible that travel over a local bump 13 and/or a local depression 12 is measured with the aid of at least one acceleration sensor 14, which is a component of the front attachment 3.

As described above, the or each acceleration sensor 14 provides a measured signal. Thus, when the measured signal has a defined curve that is characteristic in terms of intensity and duration, it can be deduced that a local bump 13 or a local depression 12 has been traveled over. As used herein, a local depression means a sudden contour change that deviates from the homogeneous course of the ground contour, which change therefore occurs suddenly and not gradually. Such a local bump or local depression generates a characteristic signal curve in the signal of the particular acceleration sensor 14, which signal curve has a relatively high intensity over a relative short time period. The travel over a local, suddenly or spontaneously occurring bump 13 or depression 12, is therefore easily and reliably deduced.

When travel over such a local bump 13 and/or local depression 12 is deduced on the basis of the measured signal of the or each acceleration sensor 14, then, according to the invention, control measures are implemented to prevent resultant pitch motions and/or rolling motions from negatively affecting the working height X of the front attachment 3 relative to the field 4, across the width of the front attachment.

When it is determined, on the basis of the measured signal of the or each acceleration sensor 14, that the front attachment 3 has been set into pitch motions as a result of the travel over a local bump 13 or a local depression 12, the lifting-unit cylinder 5 is activated in order to actively compensate for these pitch motions on the front attachment 3. More specifically, the front attachment 3 is actively raised and/or actively lowered by the lifting-unit cylinder 5 in order to compensate for such pitch motions on said front attachment. However, if it is determined, on the basis of the measured signal of the acceleration sensor 14, or each acceleration sensor 14, that the front attachment 3 has been set into rolling motions as a result of the travel over a local depression 12 or a local bump 13, these rolling motions are preferably passively counteracted by activating the cross-leveling cylinder 11. To this end, the cross-leveling cylinder 11 is activated in such a way that said cross-leveling cylinder preferably assumes a so-called floating position, and so the front attachment 3 is then decoupled from the carrier vehicle 2′ with respect to the cross-leveling cylinder 11. In this case, inertial forces of the front attachment 3 are then used to passively counteract rolling motions, so that said rolling motions are not transferred to the front attachment 3.

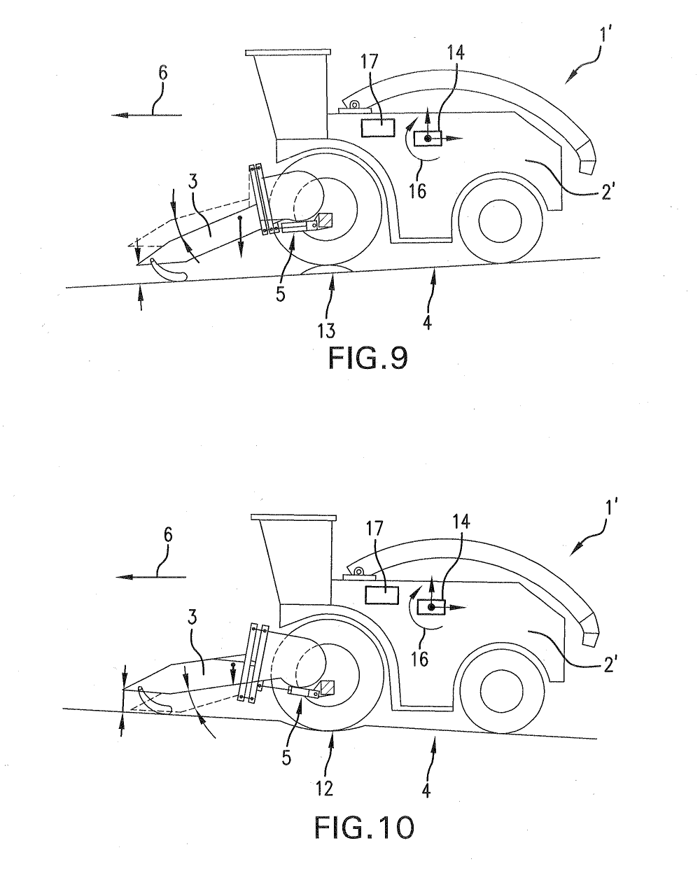

FIGS. 7 and 9 show effects of the method according to the invention during travel over a local bump 13. Due to the decoupling of the front attachment 3 from the carrier vehicle 2′, with respect to the cross-leveling cylinder 11, by the control, it can be ensured that rolling motions 15 of the carrier vehicle 2′, which are induced in the carrier vehicle 3 by the travel over the local bump 15, are not transferred to the front attachment 3 and do not therefore negatively affect the working height X of the front attachment 3 across the width thereof.

According to FIG. 9, in order to neutralize or compensate for pitch motions 16 induced by the travel over the local bump 13, the front attachment 3 is initially actively lowered by means of the lifting-unit cylinder 5, specifically as compared to the position of the front attachment 3, indicated in FIG. 9 with a dashed line, which position would set in according to the prior art, and the front attachment 3 is then actively lowered again after the bump 13 has been traveled over. The lifting speed and the lifting duration are determined as a function of the measured acceleration. FIGS. 8 and 10 show the effect of the method according to the invention when traveling over a local depression 12. In this case, rolling motions 15 induced in the carrier vehicle 2′ by the travel over the local depression 12 are not transferred to the front attachment 3, due to the activation of the cross-leveling cylinder 11, since the front attachment is decoupled from the carrier vehicle 2′ by a suitable activation of the cross-leveling cylinder 11. Inertial forces of the front attachment 3 therefore counteract rolling motions of the front attachment. Pitch motions 16, in turn, are compensated for in that the front attachment 3 is displaced by the lifting-unit cylinder 5, specifically according to FIG. 10 in that the front attachment 3 is actively raised by the lifting-unit cylinder 5, specifically as compared to the position indicated in FIG. 10 with a dashed line, which position would set in according to the prior art.

The invention also relates to a control system for carrying out the method according to the invention. The control system comprises means for carrying out the method according to the invention, specifically at least one acceleration sensor 14 and a control unit 17. The acceleration sensor 14 can be a component of the front attachment 3 or a component of the carrier vehicle 2′.

The control unit 17 evaluates measured signals of the acceleration sensor 14, or each acceleration sensor 14 and, on the basis of this evaluation, detects whether. a local bump 13 and/or depression 12 is being traveled over. If so, the control unit 17 then activates the lifting-unit cylinder 5 and/or the cross-leveling cylinder 11 in order to prevent pitch motions and/or rolling motions from being transferred to the front attachment 3.

Pitch motions are compensated for by the lifting-unit cylinder 5, specifically by actively raising and/or lowering the front attachment 3 with the aid of the lifting-unit cylinder 5.

Rolling motions can be passively counteracted by the cross-leveling cylinder 11, specifically in that the cross-leveling cylinder 11 is transferred into a so-called floating position by suitable activations of the cross-leveling cylinder 11, in order to decouple the front attachment 3 from the carrier vehicle 2 with respect to the cross-leveling cylinder 11. Suitable activations may include, for example, an opening of valves to enable hydraulic fluid to flow into the cross-leveling cylinder 11 or to flow out of the cross-leveling cylinder 11. Such decoupling of the front attachment 3 from the carrier vehicle 2 with respect to the cross-leveling cylinder 11 provides that inertial forces of the front attachment 3 passively counteract the transfer of a rolling motion to the front attachment 3.

It also is possible to actively counteract rolling motions, specifically by suitably activating the cross-leveling cylinder 11. The front attachment 3 is actively swiveled by activating the cross-leveling cylinder 11 in order to actively compensate for rolling motions.

### LIST OF REFERENCE NUMBERS

1 harvesting vehicle
2 carrier vehicle
3 front attachment
4 field
5 lifting-unit cylinder
6 direction of travel
7 side
8 side
9 sensor device
10 sensor device
11 cross-leveling cylinder
12 local depression
13 local bump
14 acceleration sensor
15 rolling motion
16 pitch motion
17 control unit

As will be evident to persons skilled in the art, the foregoing detailed description and figures are presented as examples of the invention, and that variations are contemplated that do not depart from the fair scope of the teachings and descriptions set forth in this disclosure. The foregoing is not intended to limit what has been invented, except to the extent that the following claims so limit that.

What is claimed is:

1. A method for operating an agricultural harvesting vehicle that comprises a carrier vehicle and a front attachment, comprising the steps of:
measuring travel of the agricultural harvesting vehicle over a local ground-level change using at least one acceleration sensor; and
depending on the measured travel, counteracting pitch motions, rolling motions or both of the front attachment caused by the travel of the agricultural harvesting vehicle over the local ground-level change.

2. The method according to claim 1, wherein the local ground-level change comprises a local bump, a local depression or both.

3. The method according to claim 1, wherein the at least one acceleration sensor is positioned on the carrier vehicle.

4. The method according to claim 1 wherein the at least one acceleration sensor is positioned on the front attachment.

5. The method according to claim 1, wherein the step of measuring includes detecting a measurement signal generated by each of said at least one acceleration sensor.

6. The method according to claim 5, wherein the measurement signal is time varying and is characterized by intensity and duration.

7. The method according to claim 1, wherein the step of counteracting is implemented by activating a lifting-unit cylinder.

8. The method according to claim 7, wherein activating the lifting-unit cylinder actively raises or actively lowers the lifting-unit cylinder (5).

9. The method according to claim 1, further comprising passively counteracting rolling motions of the front attachment by activating a cross-leveling cylinder.

10. The method according to claim 7, further comprising decoupling the front attachment from the carrier vehicle by activating of the cross-leveling cylinder, whereby inertial forces passively counteract the rolling motions of the front attachment.

11. The method according to claim 1, further comprising actively counteracting rolling motions of the front attachment by activating a cross-leveling cylinder.

12. The method according to claim 11, wherein activating the cross-leveling cylinder actively swivels the front attachment.

13. A control system for controlling or regulating operation of an agricultural harvesting vehicle comprising a carrier vehicle and a front attachment, wherein the control system is configured to carry out the method of claim 1.

14. The control system according to claim 13, wherein the control system comprises the at least one acceleration sensor and a control unit.

15. The control system according to claim 14, wherein the control unit activates a lifting-unit cylinder to actively compensate tor pitch motions of the front attachment.

16. The control system according to claim 14, wherein the control unit activates a cross-leveling cylinder to passively avoid rolling motions of the front attachment.

17. The control system according to claim 14, wherein the control unit activates a cross-leveling cylinder to actively compensate for rolling motions of the front attachment.

18. The control system according to claim 14, wherein the at least one acceleration sensor is a component of the front attachment.

19. The control system according to claim 14, wherein the at least one acceleration sensor is a component of the carrier vehicle.
